(19) United States
(12) Patent Application Publication
(10) Pub. No.: US 2015/0161715 A1
(43) Pub. Date: Jun. 11, 2015

(54) USING INDOOR MAPS TO DIRECT CONSUMERS TO SALE ITEMS, SHOPPING LISTS, OR OTHER SPECIFIC LOCATIONS IN A STORE, RETAIL ESTABLISHMENT, OR OTHER GEOGRAPHIC AREA

(71) Applicant: Google Inc., (US)

(72) Inventor: Robert Brett Rose, Boulder, CO (US)

(73) Assignee: Google Inc., Mountain View, CA (US)

(21) Appl. No.: 13/788,178

(22) Filed: Mar. 7, 2013

(51) Int. Cl. G06Q 30/06

(52) U.S. Cl. CPC G06Q 30/0639

(57) ABSTRACT

Indoor navigation may be utilized in combination with predetermined location goals to guide consumers to places they do or might want to visit in a retail establishment or other space. The user may be provided with assistance in locating items on a predetermined list, such as by checking map information on the user's device and by interacting with one or more location detection devices. Statistics related to the user's shopping experience may also be provided to the user. The user can optionally allow the store to review the list, statistics, or other information so the store can analyze the presentation, how the items were found, and even what the user actually purchased.

### BACKGROUND OF THE INVENTION

People often go to stores intending to purchase specific items, but can't find them all, or forget to purchase things they intended to. Stores also have specials and coupons that customers would utilize if they knew where to find the items, but can't find them or don't see them.

Grocery stores are particularly known for causing such problems. Finding particular items on a shopping list can be time-consuming and frustrating. Even stores that are familiar to a shopper might require several trips down the same aisle looking for things that are missed the first time, are hard to see, or obscured by other products. This problem costs stores money as consumers would have purchased items if they could have found them more easily.

### BRIEF SUMMARY OF THE INVENTION

One aspect of the disclosure provides a method for locating items in a given space. This method includes receiving, at a client device, user input related to items to be located in the given space, displaying a list of the items to be purchased, and receiving a map of the given space. The method further includes identifying, relevant to the map, locations of the items to be located, determining whether the user has retrieved the item to be located, updating the displayed list based on the retrieved items, computing shopping statistics related to the retrieved items, and displaying the shopping statistics. The shopping statistics may include, for example, money saved, money left to spend, time spent, distance traveled, and number of sale items selected.

Another aspect of the disclosure provides a non-transitory computer-readable medium storing information and instructions executable by a processor for performing a method of locating items in a given space. The method performed includes receiving, at a client device, user input related to items to be located in the given space, displaying a list of the items to be purchased, and receiving a map of the given space. The method further includes identifying, relevant to the map, locations of the items to be located, determining whether the user has retrieved the item to be located, updating the displayed list based on the retrieved items, computing shopping statistics related to the retrieved items, and displaying the shopping statistics.

Another aspect of the disclosure provides a method for locating items in a given space. This method includes receiving, at a server, input related to items to be located in the given space, and generating, using the server, a map of the given space. Further, locations of the items to be located are identified in relation to the map and transmitted with the map to a user device. The method further includes receiving, at the server, information regarding the items purchased, computing shopping statistics based on the received information, and transmitting the shopping statistics to the user device. The information regarding the items purchased may identify whether the items were included in the received user input, whether the items were not included in the received user input, whether the items purchased did not include an item included in the received user input, and/or whether the items were included in an advertisement provided to the user.

### BRIEF DESCRIPTION OF THE DRAWINGS

FIG. 1 is a block diagram of a system according to aspects of the disclosure.

FIG. 2 illustrates a mobile device displaying list data according to aspects of the disclosure.

FIG. 3 illustrates a floorplan according to aspects of the disclosure.

FIG. 4 illustrates a mobile device displaying route data according to aspects of the disclosure.

FIG. 5 illustrates interaction of a mobile device with objects in relation to the floorplan.

FIG. 6 is a pictorial diagram of an item identification system according to aspects of the disclosure.

FIG. 7 is a method of locating items in a given space according to aspects of the disclosure.

### DETAILED DESCRIPTION

Indoor navigation may be utilized in combination with predetermined location goals and heuristics to guide consumers to places they do or might want to visit in a retail establishment or other space. The user may be provided with assistance in locating items on a predetermined list, such as by checking map information on the user's device and by interacting with one or more location detection devices. The location of a mobile device may also be tracked to determine where the user has been in a retail location, so that the user does not waste time going to aisles or sections of the space that they've already been. Statistics related to the user's shopping experience may also be provided to the user. The user can optionally allow the store to review the list, statistics, or other information so the store can analyze the presentation, how the items were found, and even what the user actually purchased.

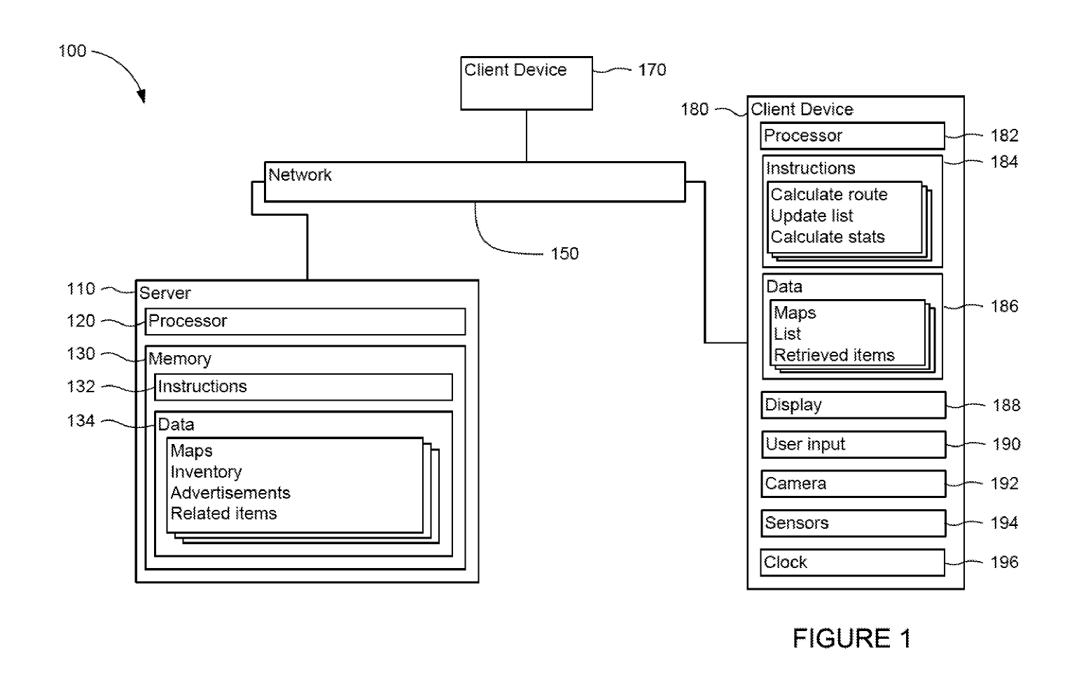

As shown in FIG. 1, an exemplary system 100 may include computers 110, 170, and 180. Computer 110 may contain a processor 120, memory 130 and other components typically present in general purpose computers. According to one example, the computer 110 may be owned or operated by, or otherwise associated with, a particular space. By way of example only, the server may be specific to a particular grocery store franchise, or to a particular store within the franchise. Other types of spaces may include, for example, department stores, flea markets, administrative or office buildings, college campuses, museums, arenas, or other facilities.

Memory 130 of computer 110 stores information accessible by processor 120, including instructions 132 that may be executed by the processor 120. Memory also includes data 134 that may be retrieved, manipulated or stored by the processor. The memory may be of any type capable of storing information accessible by the processor, such as a hard-drive, memory card, ROM, RAM, DVD, CD-ROM, write-capable, and read-only memories. The processor 120 may be any well-known processor, such as processors from Intel Corporation or Advanced Micro Devices. Alternatively, the processor may be a dedicated controller such as an ASIC.

The instructions 132 may be any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

Data 134 may be retrieved, stored or modified by processor 120 in accordance with the instructions 132. For instance, although the system and method is not limited by any particular data structure, the data may be stored in computer registers, in a relational database as a table having a plurality of different fields and records, or XML documents. The data may also be formatted in any computer-readable format such as, but not limited to, binary values, ASCII or Unicode. Moreover, the data may comprise any information sufficient to identify the relevant information, such as numbers, descriptive text, proprietary codes, pointers, references to data stored in other memories (including other network locations) or information that is used by a function to calculate the relevant data.

The data 134 may include, for example, map information, inventory information, advertisement information, information regarding items related to other items on a user's list, etc. The map information may be, for example, a collection of map of indoor areas, specifying locations of walls, entryways, rooms, and other attributes of the indoor space, such as access points and a strength of signals from the access points at various locations as measured by a particular power ratio (e.g., dBm). Such map information may be used in connection with data from client devices 170, 180 to determine location of the client devices 170, 180 and to provide navigational information to the client devices 170, 180.

The inventory information may include, for example, an accounting of items available at a particular retail location, the current cost of such items, and the like. The inventory information may also include the specific locations of the items within the retail space, such as the aisle number, x,y coordinates, floor, department name, etc. According to one aspect, the advertisement information may be linked to the inventory information, so as to indicate which inventory items are currently on sale, or have coupons or other offers associated with them. According to another example, the inventory information may be associated with the related items information. In this regard, if the user is looking for a given item, suggestions for other similar or related items may be offered to the user. For example, “coffee” may be related to “coffee filters” or “creamer,” or X Brand Coffee may be related to Y Brand Coffee. The association may be made using, for example, a table, spreadsheet, pointer, or any other mechanism for linking data.

The advertisements may be directed to items within a given space or nearby spaces. According to one example, the advertisements may be linked to particular areas in a given map, such that the advertisements are delivered to the client devices 170, 180 when the client device reaches a predetermined location within the space represented by the map.

The related items stored in data 134 may be, for example, a table or other data structure linking some items to other items. In this regard, when one item is input by the user or retrieved by the user, other related items may be suggested.

Although FIG. 1 functionally illustrates the processor and memory as being within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Similarly, the processor may actually comprise a collection of processors which may or may not operate in parallel.

The computer 110 may be at one node of a network 150 and capable of directly and indirectly communicating with other nodes of the network. For example, computer 110 may comprise a web server that is capable of communicating with client devices 170, 180 via network 150 such that server 110 uses network 150 to transmit and display information to a user on display of client device 170. Server 110 may also comprise a plurality of computers, e.g., a load balanced server farm, that exchange information with different nodes of a network for the purpose of receiving, processing and transmitting data to the client devices. In this instance, the client devices will typically still be at different nodes of the network than any of the computers comprising server 110.

Each client device may be configured similarly to the server 110, with a processor 182 and memory including instructions 184 and data 186. Each client computer 170, 180 may be a personal computer having all the internal components normally found in a personal computer such as a central processing unit (CPU), display device 188 (for example, a monitor having a screen, a projector, a touch-screen, a small LCD screen, a television, or another device such as an electrical device that is operable to display information processed by the processor), CD-ROM, hard-drive, user input 190 (for example, a mouse, keyboard, touch-screen or microphone), speakers, modem and/or network interface device (telephone, cable or otherwise) and all of the components used for connecting these elements to one another. Moreover, computers in accordance with the systems and methods described herein may comprise any device capable of processing instructions and transmitting data to and from humans and other computers including general purpose computers, PDAs, network computers lacking local storage capability, set-top boxes for televisions, and other networked devices.

Although the computers 170, 180 may comprise a full-sized personal computer, the system and method may also be used in connection with mobile devices capable of wirelessly exchanging data with a server over a network such as the Internet. By way of example only, client device 180 may be a wireless-enabled PDA, hand-held navigation device, tablet PC, netbook, or a cellular phone capable of obtaining information via the Internet. The user may input information, for example, using a small keyboard, a keypad, or a touch screen.

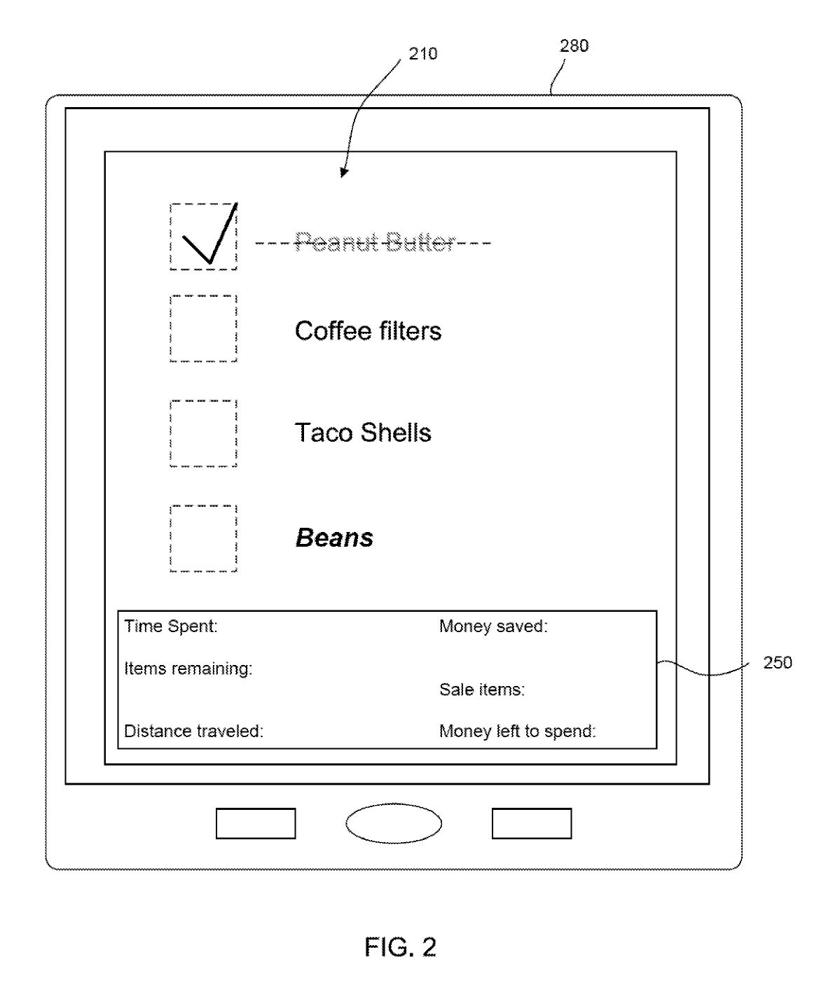

The server 110 and client computers 170, 180 are capable of direct and indirect communication, such as over network 150. Although only a few computers are depicted in FIGS. 1-2, it should be appreciated that a typical system can include a large number of connected computers, with each different computer being at a different node of the network 150. The network, and intervening nodes, may comprise various configurations and protocols including the Internet, World Wide Web, intranets, virtual private networks, wide area networks, local networks, private networks using communication protocols proprietary to one or more companies, Ethernet, WiFi (such as 802.11, 802.11b, g, n, or other such standards), and HTTP, and various combinations of the foregoing. Such communication may be facilitated by any device capable of transmitting data to and from other computers, such as modems (e.g., dial-up, cable or fiber optic) and wireless interfaces.

Although certain advantages are obtained when information is transmitted or received as noted above, other aspects of the system and method are not limited to any particular manner of transmission of information. For example, in some aspects, information may be sent via a medium such as a disk, tape or CD-ROM. Yet further, although some functions are indicated as taking place on a single client device having a single processor, various aspects of the system and method may be implemented by a plurality of computers, for example, communicating information over network 150.

Client device 180 may also include components used for determining a location of the client device 180. For example, an indoor location of the client device 180 may be determined by analyzing signal strength of received signals from nearby access points, by communicating with other known devices in the indoor space. Alternatively or additionally, onboard sensors 194, such as orientation devices and other types of sensors, may be used to determine the location of the client device 180. For example, the onboard sensors 194 may include a gyroscope, an accelerometer, a compass, a step-counter, an electromagnetic field (EMF) detector, a thermometer, etc. The onboard sensors 194 may be used (e.g., in combination with software) to determine a location of the client device 180 in an indoor space. As another example of location components, client devices may also include a geographic position component to determine the geographic location. For example, client device 170 may include a GPS receiver to determine the device's latitude, longitude and altitude position. The location components may also be used to track movement of the user as the user moves about the indoor space.

The data 186 of the client device 180 may store information for assisting the user in his/her shopping experience. For example, the data 186 may include a map of a given indoor space, such map indicating where particular items within the indoor space are located. For example, the map may include the layout of a grocery store, as well as indications that fruit is in aisle 1, bread is in aisle 2, etc. Such maps may be downloaded by the user or retrieved by the system automatically as needed, for example, by accessing a particular web site or otherwise communicating with the server 110.

The data 186 may also include a list of items intended for purchase by the user. This list may be input by the user prior to or while occupying the space. It may be input by, for example, typing the items on a keypad, selecting the items from options at a given web site, scanning pictures of the items in circular or other publication, or by any other mechanism.

The data 186 may also indicate items already retrieved by the user. For example, as it is determined that the user located a desired item within the space, that item may be indicated as being a retrieved item. In this regard, as items are located by the user, they may be crossed off the user's list.

The instructions 184 may include instructions for calculating a route through the space, updating the user's list, and calculating statistics. The route calculation instructions may determine a most efficient route that includes each location corresponding to items on the users list, such as a shortest route or a fastest route. These instructions may also determine where a user has been along the route and where the user still needs to go.

The update list instructions may include instructions for adding or removing items from the user's list. For example, when items are retrieved, the update list instructions may be executed to remove the items from the list.

The calculate stats instructions may be executed to determine information related to the user's shopping experience. For example, the determined information may include a time spent in the space or looking for a particular item, a number of items retrieved or remaining on the list, a distance traveled, a number of items within a particular category, such as sale items, purchased, an amount of money saved, etc. According to one aspect, these instructions may be executed continuously while the user is within the space to provide the user with dynamic information relating to his shopping experience.

The client device 180 may also include a clock 196. This clock may be used to track an amount of time spent in the space or looking for a particular item. The clock may also be used in association with advertisements, for example, to determine whether a coupon is redeemed within a requisite time frame.

FIG. 2 illustrates a mobile device 280 displaying data according to aspects of the disclosure. The data may include list data 210, such as items desired by a user. According to one example, the list data 210 may also include items suggested to the user, such as sale items or items related to other items on the list. In the example of FIG. 2, “beans” may be a suggested item because of its relation to “taco shells.” The suggested items may be differentiated from the user's input by, for example being indicated in a different font or color. The list data 210 may also indicate to the user which items have already been retrieved. For example, it may be indicated that the user has already reached the location of and retrieved peanut butter. Accordingly, this item may be grayed, crossed out, checked off, or differentiated in any other way.

The data displayed in FIG. 2 may also include statistics data 250. For example, this statistics data 250 may include time spent, items remaining, distance traveled, money saved, number of sale items purchased, money left to spend, or any other information related to the user's shopping experience. Some statistics, such as money left to spend, may require the user to input preliminary information, such as an amount of money the user has in his pocket. Other statistics, however, may be computed automatically based on location or other information.

The statistics data 250 may be displayed as a dashboard, providing the user with a variety of real-time information. The display may include any variety of graphics or other tools for ease of reading by the user.

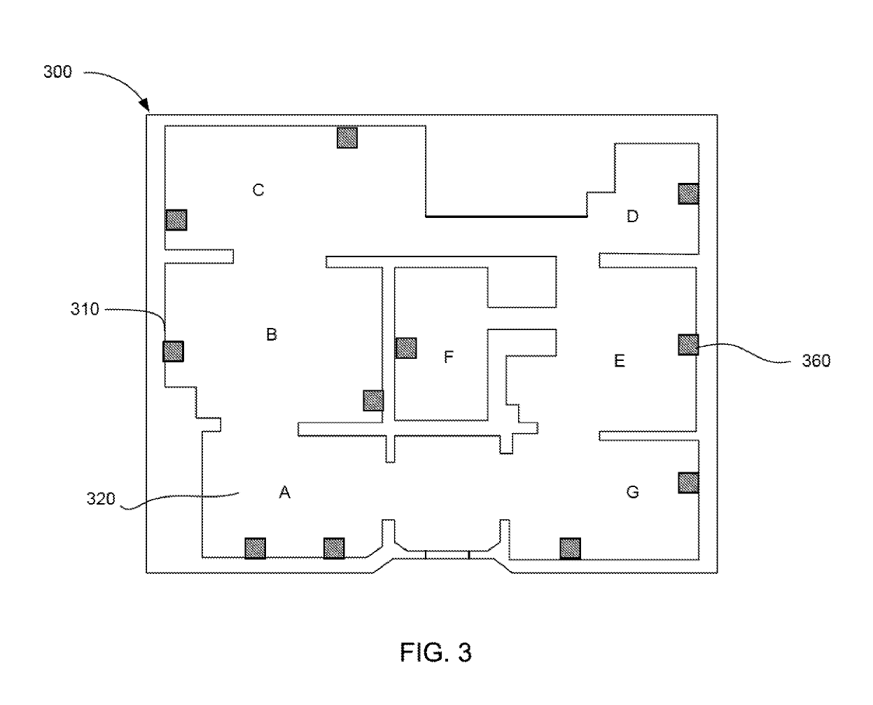

FIG. 3 illustrates a floorplan 300 according to aspects of the disclosure. This floorplan 300 may be included in map data received by the client device. The floorplan may include a plurality of boundaries 310, such as walls or other structures not passable by the user. The floorplan 300 may also include a plurality of sections 320, such as sections A-G. These sections 320 may represent aisles in a grocery store, departments in a department store, rooms in an office or other building, or the like. The floorplan 300 may also indicate a plurality of location detection devices 360. These location detection devices 360 may be, for example, access points, near field communication (NFC) readers, bluetooth devices, electromagnetic field (EMF) detectors, scannable barcodes, etc.

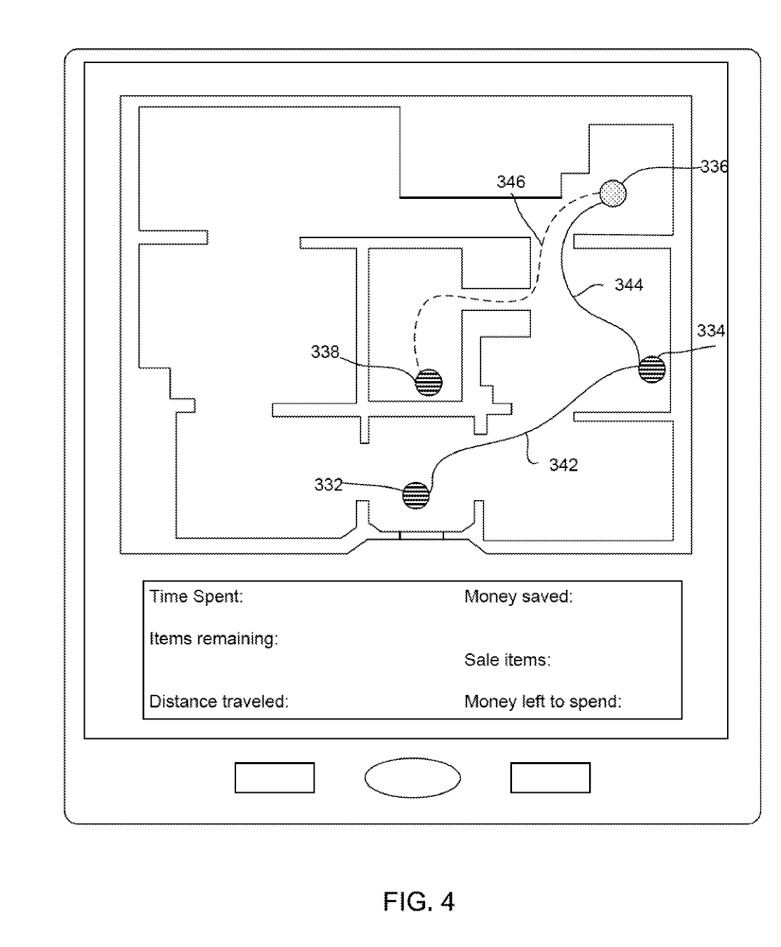

FIG. 4 illustrates a mobile device displaying route data. The route data may include one or more points 332-338 corresponding to locations of items on the users list. Some points, such as those corresponding to the current location of the mobile device or to suggested items not on the user's list, may be differentiated. For example, the point 336 corresponding to the user's current location may be shown in a different color, pattern, shape, size, etc. Paths 342-346 connecting the points 332-338 may also be shown. According to one example, the paths 342-346 may be differentiated to show which paths 342, 344 the user has already traveled, and which path 346 has not yet been taken.

According to some aspects, user may determine how data, such as list data, map data, statistics data, etc., is displayed on their device. For example, the user may elect to display all of the information at once, or to display only preferred information and accessing the other information as desired. The user may also rearrange the information, so that some information is larger or more easily readable, while other information is smaller.

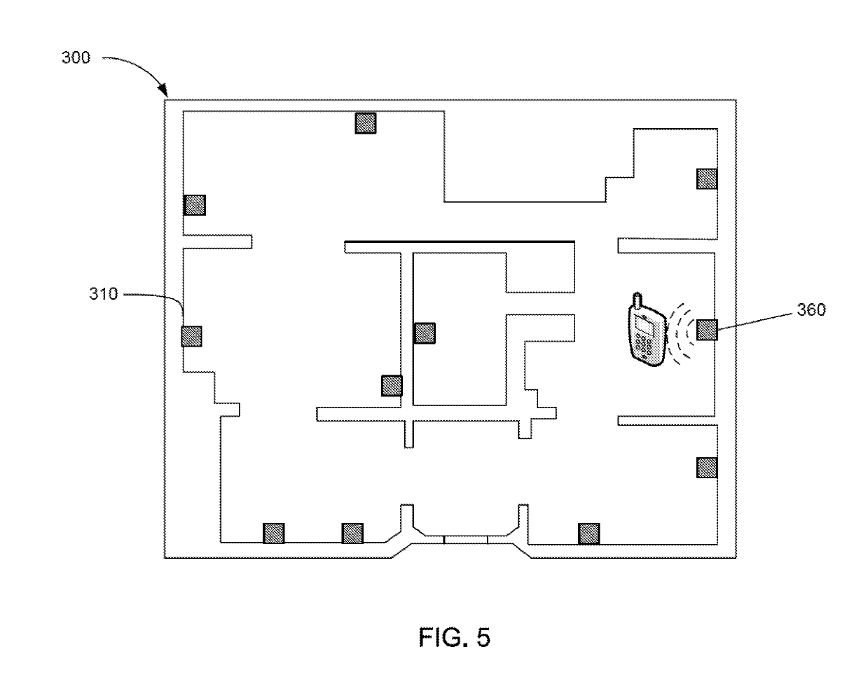

As the user travels to discrete destinations corresponding to the points 332-338, the location detection devices 360 may determine when the user reaches those destinations. FIG. 5 illustrates interaction of the mobile device with the location detection devices 360. For example, where the location detection devices 360 are NFC readers, the mobile device may detect when it comes within a predetermined range of the reader 360. Because the readers may be positioned throughout the space in correlation with particular inventory items, coming within the predetermined range may indicate that the location of a particular item on the user's list has been reached. According to some examples, this may be confirmed by prompting the user to take some action, such as respond to a query.

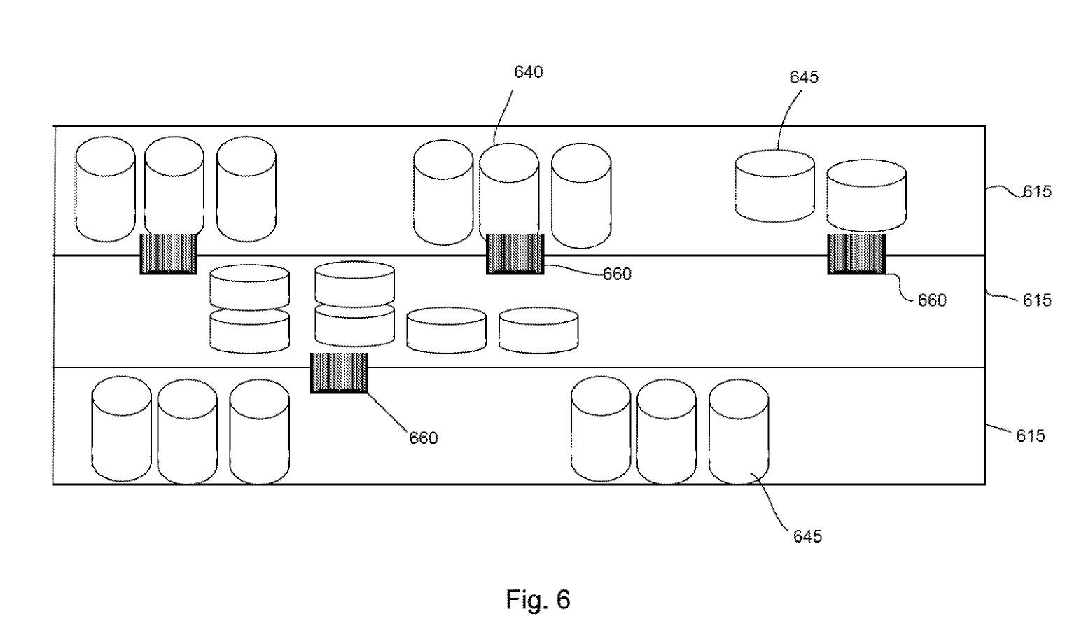

FIG. 6 is a pictorial diagram of an item identification system according to aspects of the disclosure. As mentioned above, in some examples bar codes may be used as location detection devices. For example, bar codes 660 may be placed on shelves 615 or racks, or on individual items 640, 645. When a desired item 640 is located, the mobile device may scan the bar code 660 corresponding to that item. For example, the mobile device may capture an image of the bar code using a camera or other image capture device. In this regard, it is confirmed that the desired item 640 has been retrieved, and the user's list may be automatically updated.

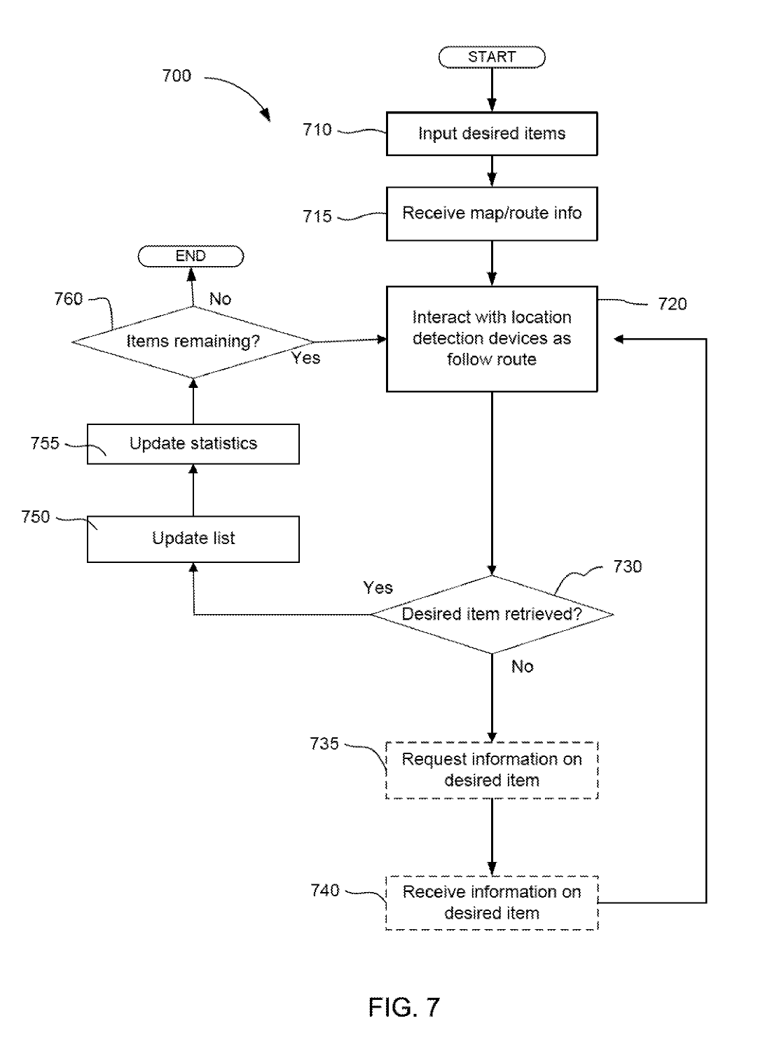

FIG. 7 is a method 700 of locating items in a given space. For example, the method 700 may be executed by the mobile device traversing a given space in pursuit of desired items on a predetermined list of desired items. While various stages of the method are illustrated and described in a particular order, it should be understood that these stages do not have to be performed in this order. Rather, various stages may be handled in a different order or simultaneously, and stages may also be added or omitted unless otherwise stated.

In block 710, input regarding desired items is received. The desired items may be input by a user, for example, through a keypad, touch-screen, voice commands, camera, download from another device, drop-down or other menu on a web site, etc. The input may be received at any time prior to the user entering the space, or while the user is occupying the space. The desired items may be stored and presented to the user on a display in the form of a list.

In block 715, map and route information is received at the mobile device from, for example, a server associated with the space. The map information may indicate a layout of the space, including aisles, departments, floors, or the like, and may also indicate where the desired items are located in that layout. For example, the locations of the desired items may be represented by dots on the map or any other symbol. A route from the entrance of the store or from the current location of the mobile device may also be provided in relation to the map layout. For example, a dashed line connecting the dots representing the desired items may provide the user with a preferred (shortest, fastest, or other) route that includes a discrete path between each desired item and the next. According to one example, the route may be modified by the user. Moreover, the route may indicate where the mobile device has already traveled, and where it has not yet gone.

In block 720, the mobile device interacts with the location detection devices as the mobile device travels throughout the space. For example, where the location detection devices are NFC readers, they will detect the mobile device as it comes within a predetermined distance. Where the location detection devices are access points, the mobile device may continually receive signals from one or more access points, and location may be computed based on signal strength. Where the location detection devices are bar codes, the mobile device may scan the relevant bar code when a desired item is located.

In block 730, it is determined whether the desired item has been retrieved by the user. For example, it may be automatically determined that the item has been retrieved if the mobile device comes within the predetermined range of the NFC reader or location detection device, or scans the bar code. Alternatively, when the mobile device comes within the predetermined range, a prompt may be displayed to the user requesting confirmation as to whether the desired item was located. According to another example, image recognition may be used. For example, the mobile device camera may receive images as the user traverses the space. The images may be compared to images of the desired items, and if a match is found, it may be determined that the desired item was retrieved.

If it is determined that the desired item was not retrieved, the method 700 may return to block 720. In some examples, the mobile device may first request additional information regarding the desired item (block 735) and receive such additional information (block 740). For example, the mobile device may request and receive an update of the item's location, further details on the item's location (e.g., which shelf), a picture of the desired item, or the like. According to some examples, provisions may be made to skip an item on the list if it cannot be located. For example, if an item is not in inventory anymore, the user can skip the item so that the method 700 does not get stuck in an endless loop.

If in block 730 it is determined that the desired item was retrieved, the list of desired items is updated (block 750). For example, as discussed in connection with FIG. 2, items may be removed from the list, crossed out, grayed out, checked off, or distinguished in any other way.

In block 755, statistics related to the user's shopping experience are updated. For example, these statistics may indicate an amount of time spent locating one or more items, the number of items already retrieved and/or remaining on the list, the distance traveled throughout the space, money saved (e.g., by selecting a particular brand or using a coupon), sale items purchased, money left to spend, et. The statistics may also be related to departures from the route provided to the mobile device. For example, if the user chooses a different route, statistics indicating a difference in time, distance, or items passed along the way may be computed.

The updated statistics may be displayed on the mobile device. According to some examples, the user may select which statistics are displayed at any given time. The statistics may also be updated independently of locating an item. For example, the statistics may be continually updated so that the user has real-time information regarding his shopping experience.

In block 760, it is determined whether any items remain on the user's shopping list. In other words, it is determined whether any desired items have not yet been retrieved. If there are remaining items on the user's list, the method 700 may return to block 720. However, if all items have been retrieved, the method 700 may end.

Though not shown in FIG. 7, in some examples the user may input a “bookmark” using the client device to indicate a location to which the user desires to return. For example, in a grocery store, the user may decide that they will only buy the expensive brand of coffee if they have enough money remaining after purchasing the remaining items on the list. In this case, the user may apply a bookmark to the coffee aisle by, for example, tapping the touch-screen or issuing a voice command. The bookmark may be displayed on the map using any appropriate symbol. Moreover, an alert may remind the user of the bookmarked location if, for example, the user is approaching the cash register.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for locating items in a given space with a client device, comprising:
receiving, with one or more processors of the client device, user input related to items to be located in the given space;
providing for display, with the one or more processors, a list of the items to be purchased;
receiving, with the one or more processors, a map of the given space;
identifying, with the one or more processors, locations of the items to be located relative to the map;
receiving, using one or more location sensors of the client device, information of a location detection device in the given space;
determining, with the one or more processors based on the received information, whether the user has retrieved the item to be located;
updating, with the one or more processors, the displayed list when it is determined that the user has retrieved the item to be located;
computing, with the one or more processors, shopping statistics related to the retrieved items periodically while the user is in the given space, including at least one of a running total of time spent in the given space, a running total of time spent looking for an item, and a running total of distance traveled; and
providing for display at the client device, with the one or more processors, one or more of the shopping statistics as they are being computed.

2. The method of claim 1, wherein determining, with the one or more processors based on the received information, whether the user has retrieved the item to be located comprises:
determining whether the client device comes within a predetermined distance of any of the identified locations of the items; and
receiving confirmation that the item had been located.

3. The method of claim 1, further comprising receiving route information, the route information indicating one or more paths leading to each of the items to be located.

4. The method of claim 3, further comprising tracking the location of the mobile device to determine which paths have been traveled.

5. The method of claim 4, further comprising displaying the route information, including the paths traveled.

6. The method of claim 1, wherein computing shopping statistics comprises calculating at least one of money saved, money left to spend, time spent, distance traveled, and number of sale items selected.

7. The method of claim 1, further comprising receiving advertisements.

8. The method of claim 1, wherein updating the displayed list comprises distinguishing the retrieved items by removing them from the list, crossing them out, checking them off, or graying them out.

9. The method of claim 1, further comprising receiving bookmark information, the bookmark information identifying a location the user desires to return to.

10. A non-transitory computer-readable medium storing information and instructions executable by a processor for performing a method of locating items in a given space with a client device, the method comprising:
receiving user input related to items to be located in the given space;
providing for display a list of the items to be purchased;
receiving a map of the given space;
identifying locations of the items to be located relative to the map;
receiving, using one or more location sensors of the client device, information of a location detection device in the given space;
determining, based on the received information, whether the user has retrieved the item to be located;
updating the displayed list when it is determined that the user has retrieved the item to be located;
computing shopping statistics related to the retrieved items periodically while the user is in the given space, including at least one of a running total of time spent in the given space, a running total of time spent looking for an item, and a running total of distance traveled; and
providing for display one or more of the shopping statistics as they are being computed.

11. The method of claim 10, wherein determining whether the user has retrieved the item to be located comprises:
determining whether the client device comes within a predetermined distance of any of the identified locations of the items; and
receiving confirmation that the item had been located.

12. The method of claim 10, wherein computing shopping statistics comprises calculating at least one of money saved, money left to spend, time spent, distance traveled, and number of sale items selected.

13. The method of claim 10, further comprising:
receiving route information, the route information indicating one or more paths leading to each of the items to be located;
tracking the location of the mobile device to determine which paths have been traveled; and
displaying the route information, including the paths traveled.

14. A method for locating items in a given space with a server, comprising:
receiving, with one or more processors of the server, input related to items to be located in the given space;
generating, using the one or more processors, a map of the given space;
identifying, with the one or more processors, locations of the items to be located in relation to the map; and
transmitting to a user device, using the one or more processors, the map and identified locations;
receiving from one or more location detection devices in the given space, using the one or more processors, information of the user device;
determining, using the one or more processors based on the information received, whether the items have been retrieved;
computing, with the one or more processors, shopping statistics based on the received information periodically while the user device is in the given space, including at least one of a running total of time spent in the given space, a running total of time spent looking for an item, and a running total of distance traveled; and
transmitting to the user device, using the one or more processors, one or more of the shopping statistics as they are being computed.

15. The method of claim 14, further comprising:
providing to the user device suggestions for additional or substitute items for purchase;
wherein the shopping statistics include an amount of money saved by purchasing the additional or substitute items.

16. The method of claim 15, wherein the suggestions for additional or substitute items include advertisements.

17. The method of claim 14, further comprising:
providing to the user device a suggested route in relation to the map for locating the items; and
receiving information regarding an actual path traveled by the user device.

18. The method of claim 17, wherein the shopping statistics comprise a comparison of the suggested route and the actual path traveled.

19. The method of claim 14, wherein the shopping statistics include at least one of a list of items retrieved, a total cost of the items retrieved, available coupons for one or more of the items retrieved, and a total amount of time spent retrieving the items.

20. The method of claim 14, wherein the information regarding the items purchased identifies at least one of:
whether the items were included in the received user input;
whether the items were not included in the received user input;
whether the items purchased did not include an item included in the received user input; and
whether the items were included in an advertisement provided to the user.
